(19) United States
(12) Patent Application Publication
(10) Pub. No.: US 2023/0263098 A1
(43) Pub. Date: Aug. 24, 2023

(54) COMBINE CONCAVE

(71) Applicant: BAUER BUILT MANUFACTURING, INC., Paton, IA (US)

(72) Inventors: Vaughn L. Bauer, Paton, IA (US); Garret Johnson, Stratford, IA (US)

(21) Appl. No.: 17/652,040

(22) Filed: Feb. 22, 2022

(51) Int. Cl. A01D 41/127; A01F 12/46; A01F 12/40

(52) U.S. Cl. CPC A01D 41/127; A01F 12/46; A01F 12/40

(57) ABSTRACT

A concave for an agricultural combine includes opposite side plates or rails, each having a curved upper edge with a plurality of square notches formed in the upper edge. A series of rectangular bars are secured to the side rails via end tabs received in the notches, such that the bars are spaced longitudinally apart from one another to define uniform laterally extending gaps between adjacent bars. The concave is free from structures or obstructions in the gaps, so as to minimize plugging of the concave. Each bar has a leading edge with the radius to minimize damage to harvested grain during the threshing process.

### FIELD OF THE INVENTION

The invention is directed towards a concave for an agricultural combine for use with corn and soybeans.

### BACKGROUND OF THE INVENTION

Various concave structures are utilized in combines for harvesting corn and soybeans. In a conventional combine, the concave forms a lower cylindrical surface for a housing of a rotor. As the grain enters the housing, the rotation of the rotor compresses the grain against the perforated concave to remove the grain, which falls through the grate of the concave into a collection bin in the combine. The corn cob, stalks and chaff are discharged out of the combine.

These prior art rotary combines have several problems, including a tendency to damage the grain, and foreign material passing through the concave grate into the collection bin.

Current original equipment concaves and aftermarket alternatives utilize ⅝ inch round bars spaced apart from one another by ⅝ inch. The round bars tend to cause higher amounts of grinding of the cobbs and corn kernels, which leads to excessive wear. The round bars also cause kernels to rebound back into the rotor, instead of passing through the concave openings. Also, the round bars break the cobbs into smaller pieces, which become wedged in the slots or gaps between bars, causing blockage which restricts passage of the kernels into the collection bin. Other prior art concaves utilize flat bars, having ¼ inch thickness, and multiple supports cross the length of the bars. These bars are normally spaced ½-⅝ inch apart and have similar issues to round bars regarding kernel damage and concave blockage.

Some concaves also utilize a center support for the bars, of which increases buildup of material and further plugging of the concave.

Aftermarket options have not resolved these problems. For example, one aftermarket alternative includes wires, which causes material to wrap and further decrease the total area for grain to exit the concave.

Accordingly, a primary objective of the present invention is a provision of an improved concave which eliminates or minimizes the problems of the prior art.

Another objective of the present invention is a provision of a combine concave having transverse bars with a radiused leading edge to produce less aggressive and damaging threshing of corn kernels and beans.

Still another objective of the present invention is a provision of a combine concave having substantially rectangular bars with increased spacing there between to minimize plugging or blockage of the concave and to maximize grain pass through.

Yet another objective of the present invention is the provision of a combine concave which produces more efficient threshing of corn, with reduced foreign material in the grain tank.

Another objective of the present invention is a provision of a combine concave having flat bars with decreased wear and increased life expectancy.

These and other objectives will become apparent from the following description of the invention.

### SUMMARY OF THE INVENTION

An agricultural combine concave is provided with a pair of curved side plates with a plurality of straight flat transverse bars extending between the side plates, without any intermediate support for the bars. Each of the flat bars are constructed of ⅜ inch steel and has a leading edge with a 1/16 inch radius. The bars are spaced apart ¾ inch-1 inch to define gaps through which the threshed corn or beans pass to into a collection trough or bin in the combine. The bars have opposite ends with tabs welded into square notches in the side rails. The bars are free from interconnections between side rails so that gaps are unobstructed. The configuration of the concave minimizes damage to the grain, decreases blockage or plugging of the concave, minimizes wear on the bars, and maximizes life expectancy of the concave, all to the benefit of the farmer.

### BRIEF DESCRIPTION OF THE DRAWINGS

FIG. 1 is a side elevation view of an agricultural combine, with a portion cut away to show the internal threshing concave of the present invention.

FIG. 2 is a perspective view of the concave according to the present invention.

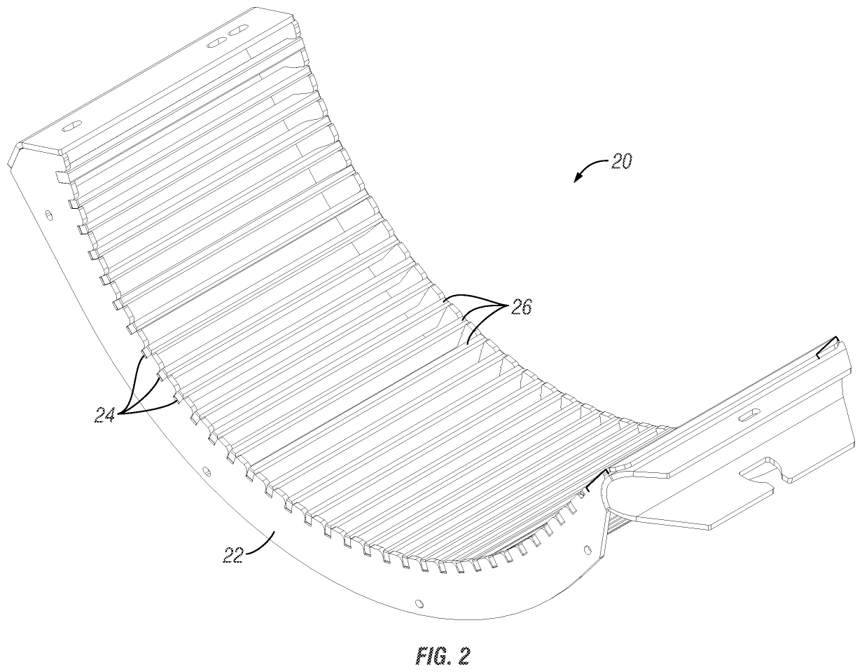

FIG. 3 is a top plan view of the concave.

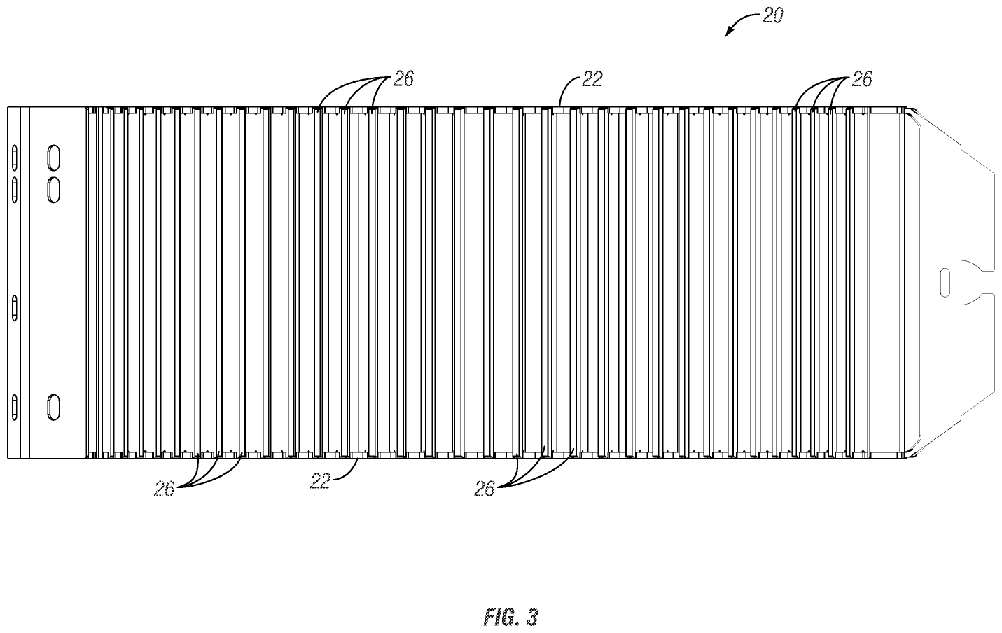

FIG. 4 is a bottom plan view of the concave.

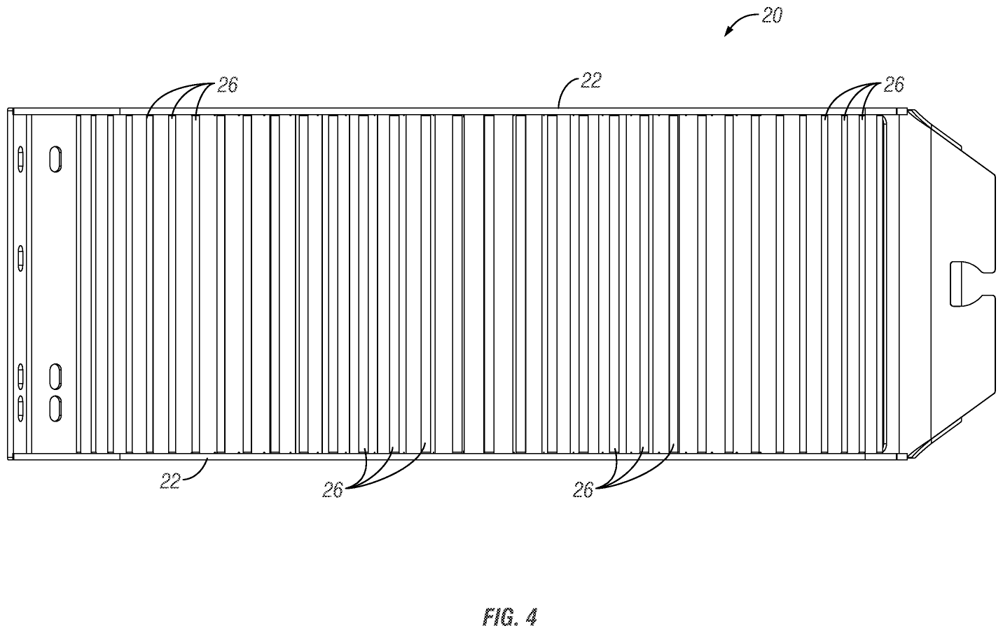

FIG. 5 is an end view of the concave, from the left end of FIG. 2.

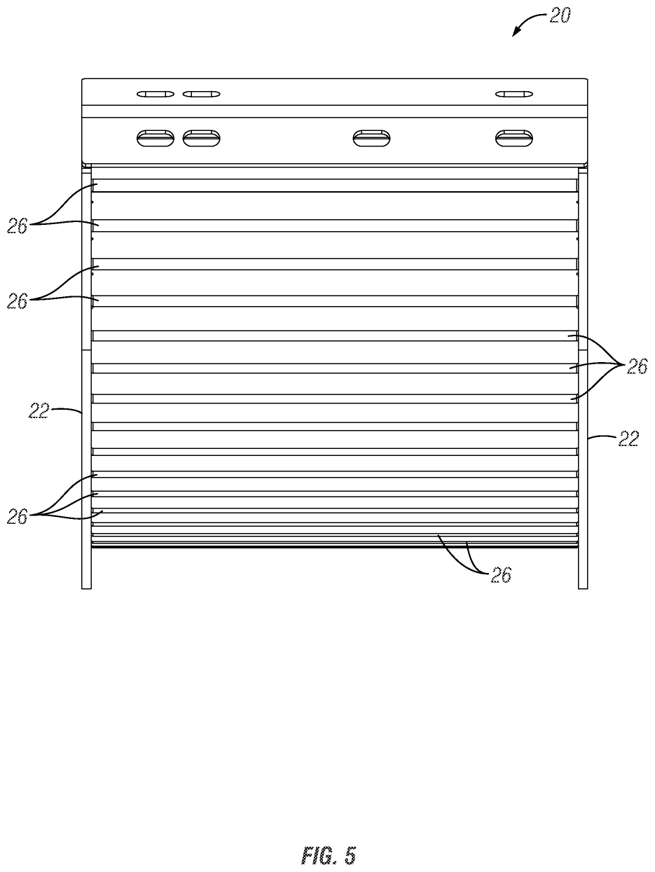

FIG. 6 is an end elevation view of the concave, from the right end of FIG. 2.

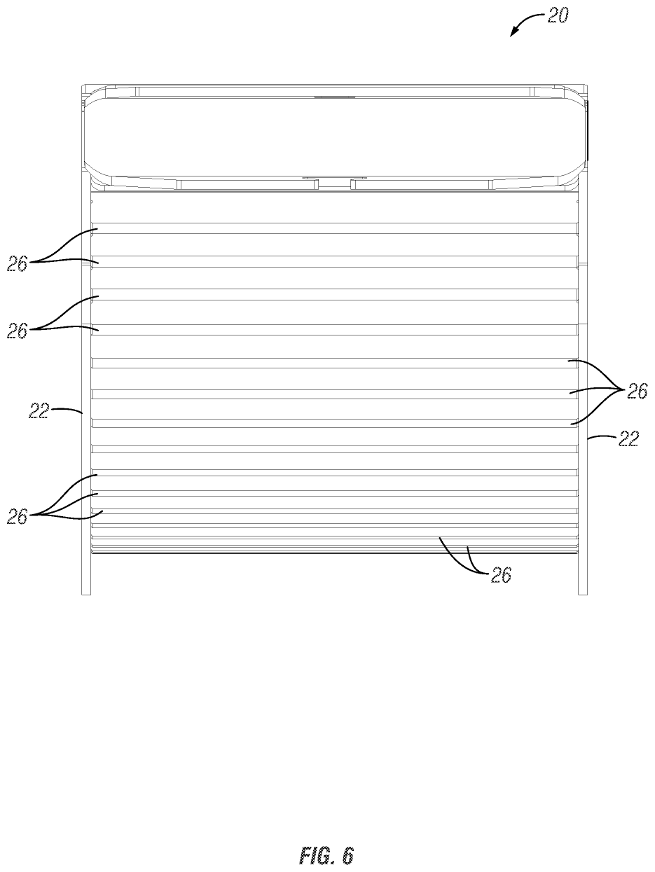

FIG. 7 is a side elevation view of the concave.

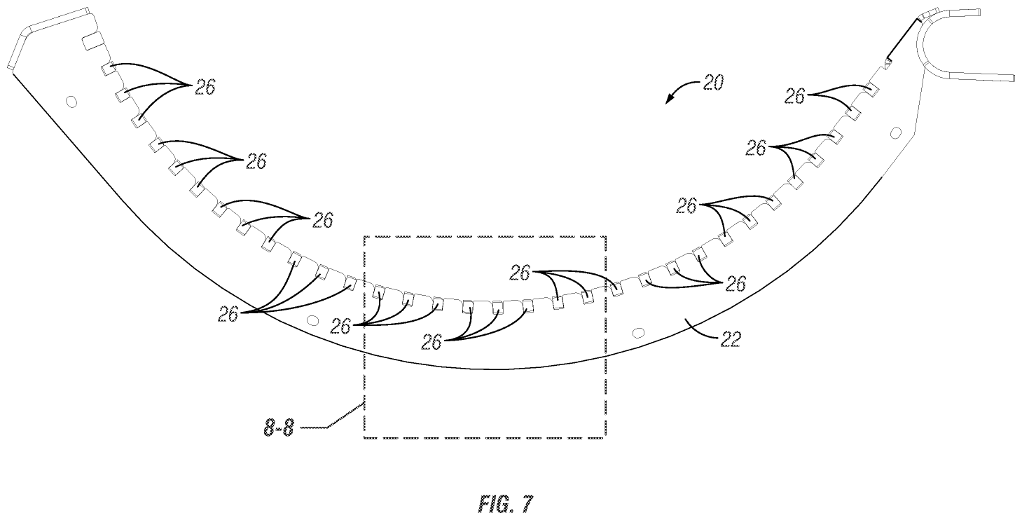

FIG. 8 is an enlarged view taken along lines 8-8 of FIG. 7.

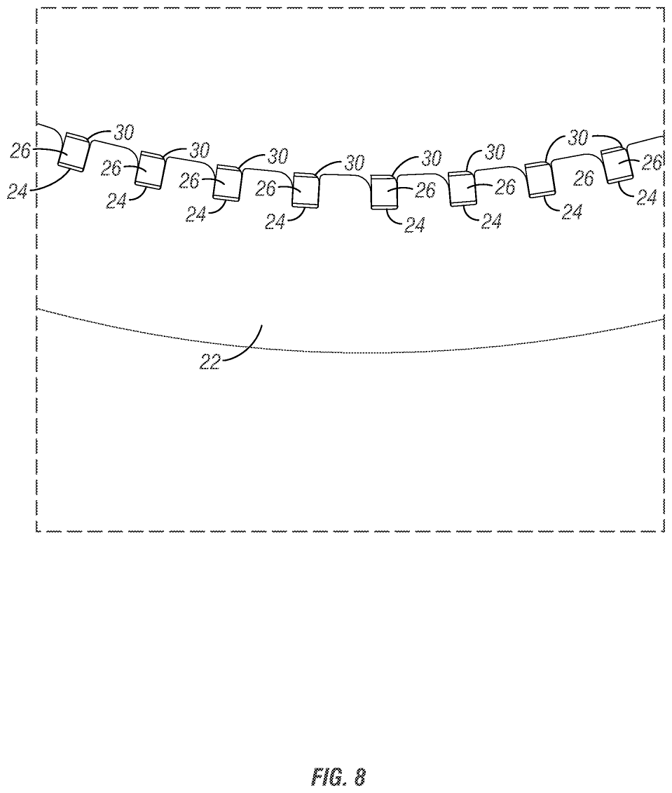

FIG. 9 is a perspective sectional view of the concave, taken along a longitudinal centerline of the concave.

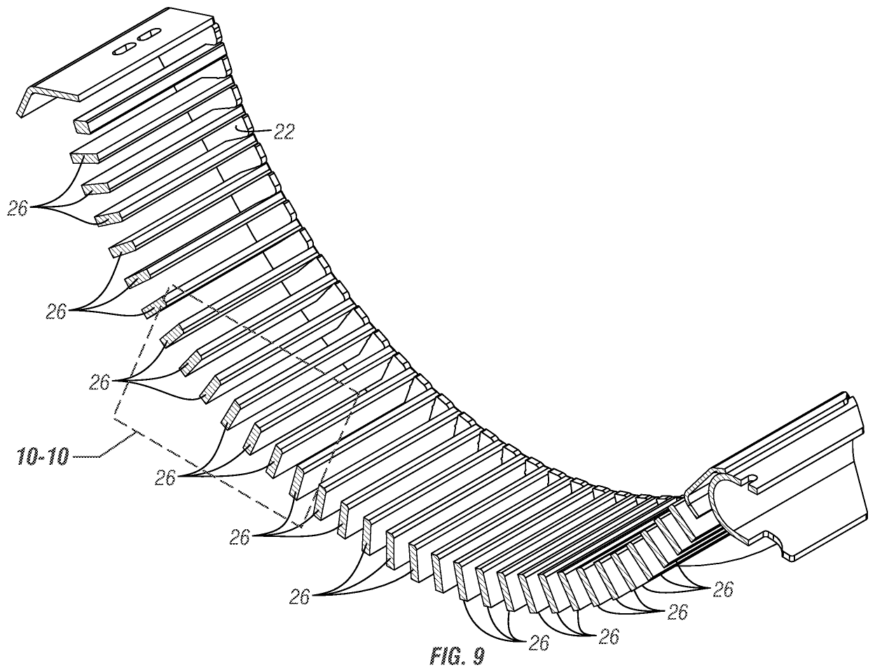

FIG. 10 is an enlarged view taken along lines 10-10 of FIG. 9.

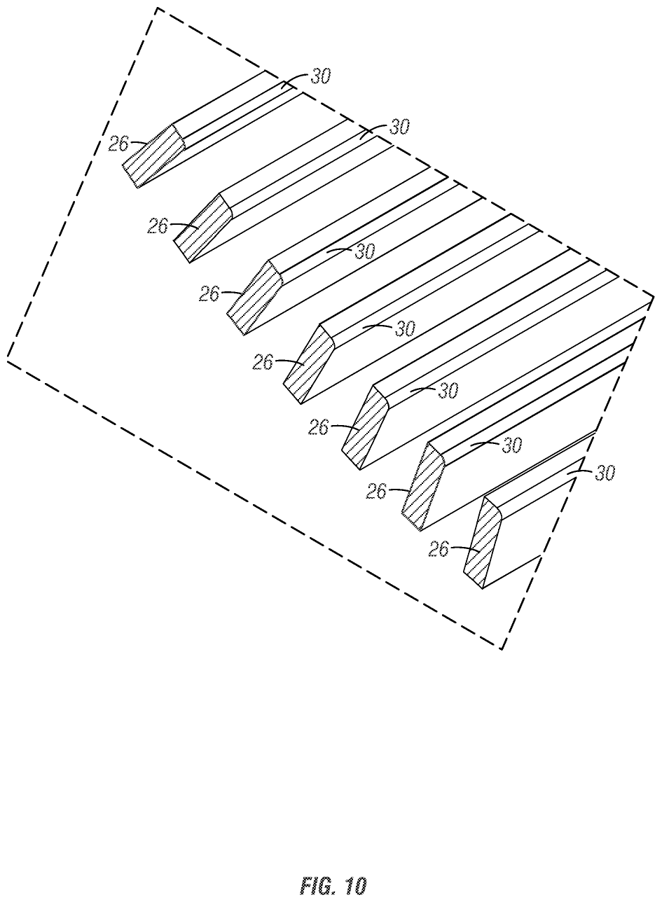

FIG. 11 is a perspective view of one of the crossbars of the concave.

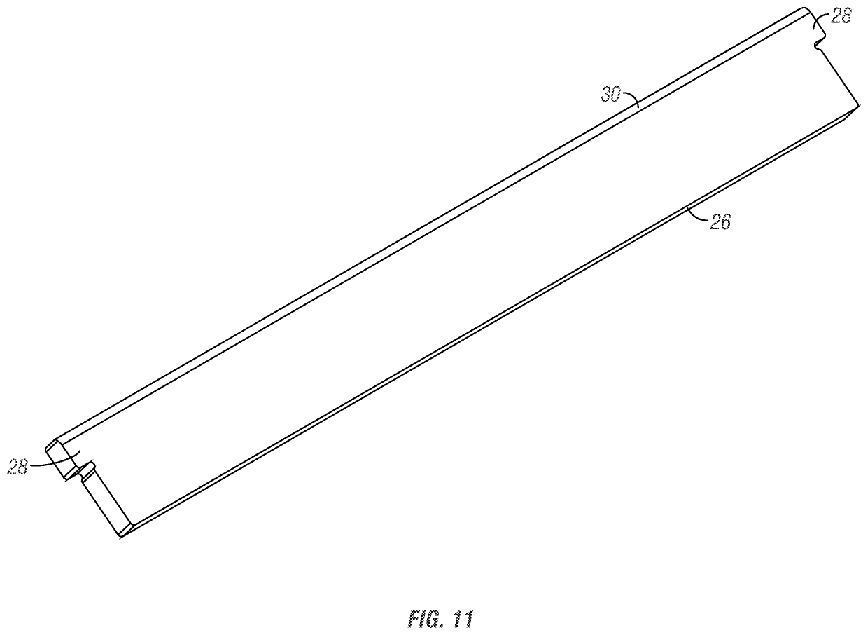

FIG. 12 is another perspective view of the crossbar shown in FIG. 11.

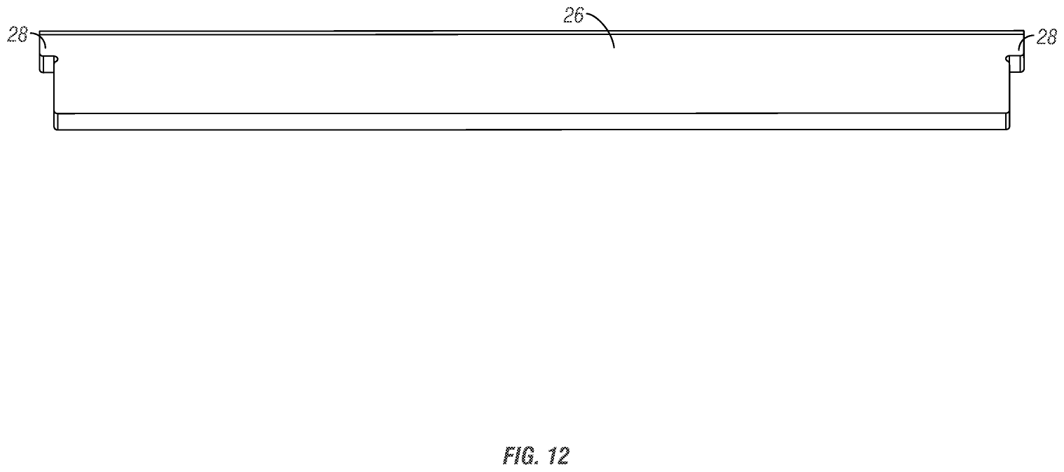

FIG. 13 is an end elevation view of the crossbar.

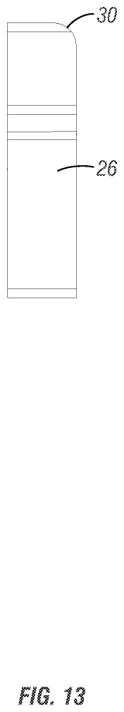

FIG. 14 is a perspective view of a series of the concaves assembled for use in the combine.

FIG. 15 is an end elevation view of the assembled concaves shown in FIG. 14.

### DETAILED DESCRIPTION OF THE INVENTION

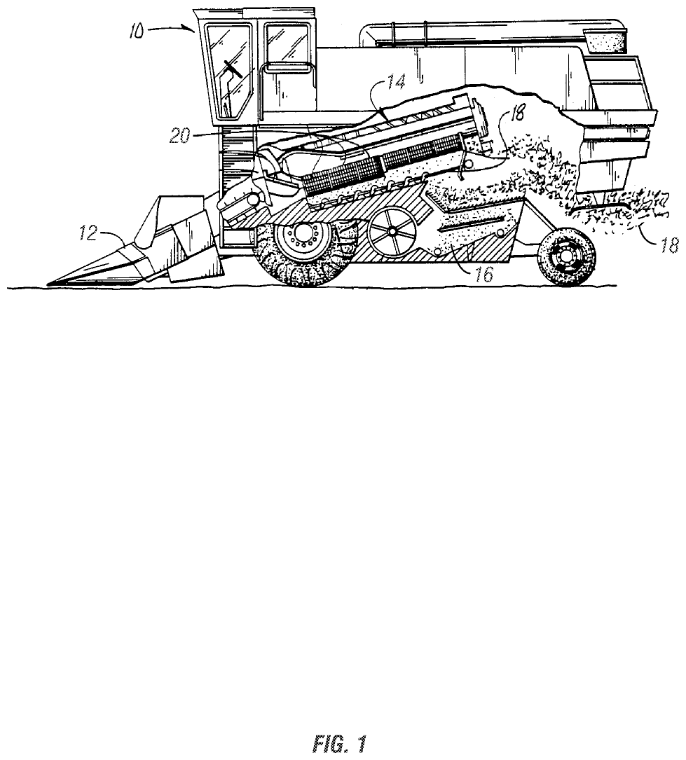

An agricultural combine is generally designated in FIG. 1 by the reference numeral 10. The combine 10 includes a head 12 for harvesting corn, soybeans, or other crops. An internal threshing cylinder 14 is provided in the combine 10 to separate the corn kernel or seed from the corn cob and stover. The cylinder 14 can also be set up to separate soybeans, or other grains, from the stalk or chaff. The separated kernel, bean, or grain then falls into a storage tank or bin in the combine 10, while the stalks, leaves, and other residue 18 is ejected out of the combine 10. The above description of the combine 10 is conventional and does not constitute a part of the present invention.

The invention is directed towards the concave 20 which works in conjunction with the cylinder 14 to achieve the threshing of the grain. The concave 20 includes a pair of spaced apart, curved side rails 22, with a series of upper notches 24 on each side rail 22. Preferably, the notches have square corners. A plurality of bars 26 extend between the side rails 22. Each bar 26 has opposite end tabs 28 sized for receipt in one of the notches 24 for mounting the bars 26 to the side rails 22. Then, the bars 26 are welded to the rails 22.

Each bar 26 is formed from flat stock steel, with a preferred thickness of ⅜ inch. The leading edge 30 of each bar 26 has a radius of, preferably, 1/16 inch. The spacing between the bars 26 is ¾ inch-1 inch so as to create consistent gaps between the bars 26, without any obstructions, structural support, or other objects between the side rails 22 or in the gaps between the bars 26.

The concave 20 provides more efficient threshing, with less damage to the kernel or bean, due to the radiused edge 30 on the forward side of the bars 26. The concave 20 also reduces foreign material passing through the concave gaps between the bars 26, thereby providing cleaner grain in the storage tank, down to approximately 0.5%. In comparison, a conventional concave allows approximate 5% foreign matter into the storage tank. The use of thickened flat bars, compared to the thinner prior art bars, also maintains the integrity of the bars, minimizes wear, and extends the useful life of the concave 20.

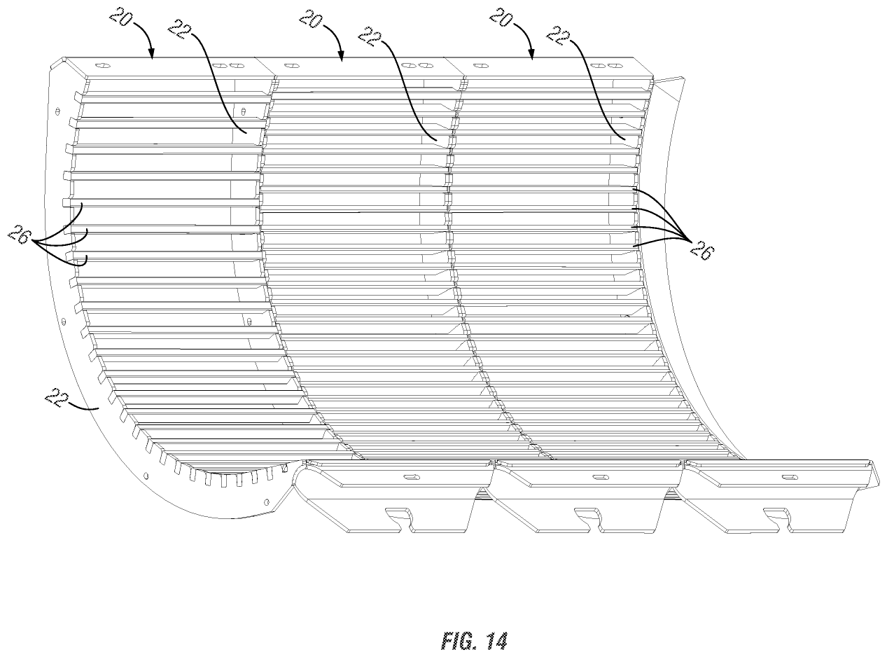

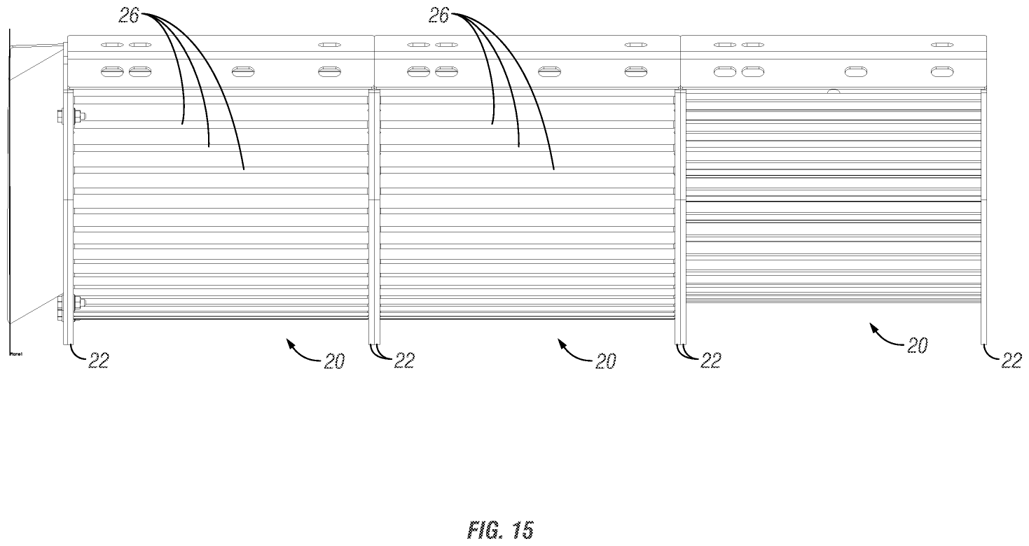

The concave 20 can be assembled in series, as shown in FIGS. 14 and 15, depending upon the length of the cylinder 14. The concave 20 can be utilized on all brands of combines, with various types and sizes of grain, with particular improvements coming with large grain harvest. For example, for seed corn, whole kernels are desirable, since broken kernels cannot be used for planting. The concave 20 minimizes kernel breakage, thus maximizing profitability for the farmer.

From the foregoing, it can be seen that the present invention accomplishes at least all the stated objectives.

What is claimed is:

1. A combine concave, comprising:
a pair of spaced apart curved side plates;
a plurality of straight flat bars each having opposite ends fixed to the side plates so that the bar extends between the side plates without any intermediate support; and
each of the flat bars having a leading edge with a radius.

2. The combine concave of claim 1 wherein each of the flat bars has a substantially rectangular cross section.

3. The combine concave of claim 1 wherein the flat bars are spaced apart and parallel to one another so as to define gaps between adjacent ones of the flat bars, and the gaps being free from any obstructions.

4. The combine concave of claim 3 wherein the gaps are at least ¾″ between adjacent pairs of the flat bars.

5. The combine claim or claim 3 wherein the gaps all have the same dimensions between each pair of bars.

6. The combine concave of claim 3 wherein each bar has a length, depth, and a thickness, with the length being greater than the depth, and the depth being greater than the thickness.

7. The combine concave of claim 5 wherein the gaps extend continuously between the side plates.

8. The combine concave of claim 5 wherein the thicknesses of the flat bars define an upper surface of the concave.

9. The combine concave of claim 1 wherein the flat bars are free from wires between the side plates.

10. The combine concave of claim 9 wherein the notches have square corners and each end of each flat bar has a tab for receipt in one of the side plate notches.

11. The combine concave of claim 1 wherein the bars are spaced at least ¾″ apart.

12. The combine concave of claim 1 wherein the bars are free from connections to one another between the side plates.

13. The combine concave of claim 1 wherein the flat bars are connected to one another only at the opposite ends.

14. A concave for an agricultural combine, comprising:
opposite side plates, each side plate having a curved upper edge with a plurality of square notches formed in the upper edge; and
a series of rectangular bars having opposite ends received in the notches of the side plates so as to be spaced longitudinally apart from one another and to define laterally extending gaps between adjacent ones of the bars, and the gaps all being equal in width and all being free from structures between the side plates.

15. The concave of claim 13 wherein the bars are supported only at their opposite ends.

16. The concave of claim 13 wherein the bars each have a rounded upper leading edge.

17. The concave of claim 15 wherein the leading edge of each bar has a radius of approximately 1/16 inch.

18. The concave of claim 13 wherein the gaps extend between the side plates without interruption.

19. The concave of claim 13 wherein the bars are spaced from ¾″-1″ from one another.

20. The concave of claim 13 wherein the gaps allow less than approximately 0.5% of foreign matter to pass therethrough.
